(19) United States
(12) Patent Application Publication
(10) Pub. No.: US 2026/0305675 A1
(43) Pub. Date: Oct. 8, 2026

(54) FRY BATTER COMPOSITION

(71) Applicant: CORN PRODUCTS DEVELOPMENT, INC., Westchester, IL (US)

(72) Inventors: Himanshu SHAH, Bridgewater, NJ (US); Samuel HORMEL, Bridgewater, NJ (US)

(21) Appl. No.: 19/483,021

(22) PCT Filed: May 10, 2024
(86) PCT No.: PCT/US2024/028732

§ 371 Date: Nov. 10, 2025

Related U.S. Application Data
(60) Provisional application No. 63/503,069, filed on May 18, 2023.

(51) Int. Cl. A23P 20/10; A23L 11/00; A23P 20/12; A23P 20/15

(52) U.S. Cl. CPC A23P 20/105; A23L 11/00; A23P 20/12; A23P 20/15

(57) ABSTRACT

This specification discloses a dry solids coating composition comprising separately by weight: a) 5% to about 35% of a legume protein isolate and b) from about 45% to about 95% of a starch mix (wt %). The dry coating can be used to coat an edible substrate or can be part of a fry batter that is used to coat an edible substrate. Advantageously, the dry mixes can be used to increase the protein content of a coating for while maintaining crispness.

Disclosed herein are dry solids coating composition comprising a legume protein isolate. Also disclose are fry batters comprising a legume protein isolate and food products coated with a legume protein isolate.

In one aspect the technology disclosed in this specification describes dry solids coating compositions with elevate protein compared to flour containing coating compositions. The dry solids coating compositions can be used to coat a food product as a dry powder or can be mixed with aqueous solution to form a fry batter. The coating or fry batter can be used to coat a food product, in particular a substrate that has high moisture content like a sweet potato product, a shrimp product, or a fish product (as opposed to a potato product or chicken product).

In another aspect this specification describes dry solids coating compositions and batters comprising the dry solids coating compositions that provide good crispness to a food product that has been one or more of fried, baked, and frozen. For example, by way of illustration, an edible substrate, for example a vegetable or a meat product, but more preferably a high moisture content product like a sweet potato product, a shrimp product or a fish product (as opposed to a potato product or chicken product) may be coated with the dry solids coating composition or a batter comprising the dry solids coating composition and fried, frozen, and then re-baked, wherein the re-baked end-product has good crispness. In such case the fry coating provide desirable texture and added protein to what would otherwise be a low protein food product.

It is further observed that claimed fry coatings provide higher crispness than fry coatings that do not comprises a legume protein isolate. More specifically, it is observed that the claimed fry coatings provide higher crispness when using pea protein isolate.

In any embodiment this specification describes a dry solids coating composition comprising separately by weight: a) 5% to about 35%, or to about 30%, or to about 25%, or from 7.5% or to about 35%, or to about 30%, or to about 25%, from about 10% to about 35%, or to about 30%, or to about 25%;, b) from about 45% to about 95% of a starch mix (wt %) or from about 45% to about 90%, or from about 45% to about 85%, or from about 45% to about 75% or from about 45% to about 65% or from about 45% to about 55%. In any embodiment the legume protein isolate is selected from the group consisting of pea protein isolate, fava bean protein isolate, and lentil protein isolate. In at least some embodiments the legume protein isolate is a pea protein isolate

In any embodiment described in this specification a dry solids coating comprise a starch mix that comprises one or more of a legume flour, wheat flour, tapioca starch or waxy tapioca starch and a rice flour. In at least some embodiments described in this specification a dry solids coating comprises a tapioca starch or waxy tapioca starch and a rice flour.

In any embodiment described in this specification describes a dry solids coating comprising a starch mix that comprises a high amylose corn starch, wherein, the high amylose corn starch has amylose content greater than about 50%.

In any embodiment described in this specification a dry solids coating comprising a starch mix that comprises a thermally inhibited starch, optionally wherein the thermally inhibited starch is a tapioca starch or waxy tapioca starch.

In any embodiment described in this specification a dry solids coating comprising a starch mix that comprises a. from 15% to 40% (wt. %) of a thermally inhibited starch or from about 20%, or from 25% or from 30% to 40%; b. from 15% to 40% (wt. %) of a rice flour or from about 20%, or from 25% or from 30% to 40%; c. from about 5% to about 20% (wt. %) of a high amylose corn starch or from about 10% to about 20%, wherein the high amylose corn starch has starch content greater than about 50% (wt. % or the high amylose starch %); d. a dextrin in an among from 5% to 20% (wt. %) or from about 5% to about 15%.

In any embodiment described in this specification a dry solids coating comprising a starch mix that consists essentially of: a. from 15% to 40% (wt. %) of a thermally inhibited starch or from about 20%, or from 25% or from 30% to 40%; b. from 15% to 40% (wt. %) of a rice flour or from about 20%, or from 25% or from 30% to 40%; c. from about 5% to about 20% (wt. %) of a high amylose corn starch or from about 10% to about 20%, wherein the high amylose corn starch has starch content greater than about 50% (wt. % or the high amylose starch %); d. a dextrin in an among from 5% to 20% (wt. %) or from about 5% to about 15%.

In another aspect, this specification describes fry batters comprising a dry solids composition as described in this specification. In any embodiment described in this specification a fry batter comprising a dry solids coating composition as described in this specification and an aqueous solution, wherein the dry solids coating composition is in an amount from about 25% to 40% (wt. %) or from about 30% to about 40%, or about 32% to about 38%. Most commonly the aqueous solution will be water, but milk, or juice, or vinegar or other common cooking liquid or some combination there of may be used as the aqueous solution.

In another aspect this specification describes food product comprising either the dry solids coating composition or a fry batter comprising the dry solids coating composition. In various embodiments the of the food product the dry solids coating composition or fry batter coats an edible substrate. The edible substrate may be any suitable food product including but not limited to meat (beef, pork, chicken or poultry, fish, or shellfish. In other embodiments of the food products described in this specification a dry solids composition or fry batter coats a cheese or cheese product. In other embodiments of the food products described in this specification a dry solids composition or fry batter coats a non-animal-based substrate, most commonly a vegetable or vegetable composition, where a vegetable composition may be made mixed vegetables or dough comprising vegetable and starch or flour or potato based binding system. In other embodiments of the food products described in this specification a dry solids composition or fry batter coats a vegetable such as squash, or potato, or sweet potato or carrot, etc.

In various embodiments of the food product described in this specification the substrate is partially or fully cooked before coating with the dry solids coating composition or fry batter. The substrate, whether cooked or raw, is coated using common methods in the industry. Once coated the food product may be cooked, for example by frying or baking, or may be stored without cooking the coated food product. If cooked the food may be frozen and may be re-heated from frozen or after thawing.

In at least some embodiment the food product is a cooked food product (whether frozen or re-heated). During the cooking process much of the moisture in the fry batter lost during the cooking process. Accordingly, the weight ratios of the ingredients in the coating on the food product will be like those in the dry solids coating composition (even if the composition was applied to the food product as a batter.

In any embodiment a dry solids coating composition as described in this specification may include other ingredients than a starch mix and legume protein isolate. In any embodiment a fry batter as described in this specification may include other ingredient than a starch mix, a legume protein isolate and aqueous solution. Other ingredients include oils and fats, syrups, honey, colorants, flavor modifying molecules, flavoring extracts. Other ingredients also include salt, seasonings, preservatives, and leavening agents.

In various embodiments described in this specification a starch mix used in a dry ingredient coating mix or fry batter comprises high amylose corn starch. High amylose corn starches are products known in the market. The following comments are provided to aid in understanding the term high amylose corn starch but are not intended to limit the full understanding of that term in the art. Common dent corn has amylose content of about 25%. High amylose corn starches, in contrast are specially bred corn varieties having amylose content substantially above 25%, for example at least about 40% amylose content by weight. More common commercial variants have amylose content from about 50% to about 60%, a range from about 65% to about 75%. Higher amylose content corn starch may also exist.

In any embodiment described in this specification a dry ingredient coating composition or a fry batter comprises a legume protein isolate. Legume protein isolates are a class of product derived that separate legume protein from other components naturally in the legume. Legume protein isolates, including pea protein isolate, fava bean protein isolates, lentil protein isolate, etc. are already on sale and can be made by a variety of methods. With this specification legume protein isolates are not further modified, for example by hydrolysis, or by enzymatic or chemical reaction, like deamidation. An example or a legume protein isolate and method of manufacture is disclosed in International Patent Publication WO2022/192646, which is incorporated herein in its entirety by reference.

In any embodiment described in this specification a dry ingredient coating composition or a fry batter comprises a starch mix. Within this specification, the term starch mix is used to refer to all starch and starch derivatives in the dry ingredient coating composition so that any starch, starch derivative, or flour within the dry ingredient coating composition or fry batter are within the starch mix and there are no starches, starch derivatives or flours in the dry ingredient coating composition and fry batter. Starch derivatives include but are not limited dextrin and maltodextrins and acid converted starches, but exclude dextrose, fructose, and various corn or other starch-based syrups. In some embodiments, starches include chemically modified starches and starches modified by physical means such as heat and moisture, including pregelatinized starches. In at least some embodiments, however, the starch mix excludes chemically crosslinked, chemical stabilized (i.e. using acetyl groups or hydropyropyl groups) and exclude succinic acid modified starch (e.g. octenyl succinate modified starches). In some embodiments the starch mix comprises a thermally inhibited starch. Flours, starches and dextrin useful for a dry ingredient coating composition or a fry batter may be from any useful plant source including but not limited corn, rice, tapioca, sago, legumes, such as pea, fava bean, lentil and chickpea, and potato as well as high amylose and low amylose variants. In some embodiments some of the legume starch may come from residual starch in a legume protein isolate. In other embodiments, however, legume starches and legume flours are excluded from the starch mix. Among common flours, both gluten containing and gluten free flours may be used. In some embodiments, however, starch mix is gluten free

Thermally inhibited starch refers to a class of that are processed to function like chemically crosslinked starch without the use of chemical crosslinker. Thermally inhibited starches exist on the market and are described for example in International Patent Publication WO2020/139997 which incorporated herein by reference in its entirety.

Use of “about” to modify a number is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

The technology disclosed in this specification can be better understood with reference to the following aspects, which are not intended to limit the full scope of the disclosed technologies.
1. A dry solids coating composition comprising separately by weight: a) 5% to about 35%, or to about 30%, or to about 25%, or from 7.5% or to about 35%, or to about 30%, or to about 25%, from about 10% to about 35%, or to about 30%, or to about 25%; b) from about 45% to about 95% of a starch mix (wt %) or from about 45% to about 90%, or from about 45% to about 85%, or from about 45% to about 75% or from about 45% to about 65% or from about 45% to about 55%
2. The dry solids coating composition of claim 1 wherein the starch mix comprises one or more of a legume flour, a wheat flour, a tapioca starch, waxy tapioca starch and a rice flour, wherein optionally the dry solids coating comprises a tapioca starch, waxy tapioca starch, and a rice flour.
3. The dry solids coating composition of claim 1 or 2 wherein the starch mix further comprises a high amylose corn starch, wherein, the high amylose corn starch has amylose content greater than about 50%.
4. The dry solids coating composition of any one of claims 1 to 3 wherein the starch mix comprises a thermally inhibited starch, optionally wherein the thermally inhibited starch is a tapioca starch or waxy tapioca starch.
5. The dry solids coating composition of any one of claims 1 to 4 wherein the starch mix comprises: a. from 15% to 40% (wt. %) of a thermally inhibited starch or from about 20%, or from 25% or from 30% to 40%; b. from 15% to 40% (wt. %) of a rice flour or from about 20%, or from 25% or from 30% to 40%; c. from about 5% to about 20% (wt. %) of a high amylose corn starch or from about 10% to about 20%, wherein the high amylose corn starch has starch content greater than about 50% (wt. % or the high amylose starch %); d. a dextrin in an among from 5% to 20% (wt. %) or from about 5% to about 15%.
6. The dry solids coating composition of any one of claims 1 to 4 wherein the starch mix consists essentially of: a. from 15% to 40% (wt. %) of a thermally inhibited starch or from about 20%, or from 25% or from 30% to 40%; b. from 15% to 40% (wt. %) of a rice flour or from about 20%, or from 25% or from 30% to 40%; c. from about 5% to about 20% (wt. %) of a high amylose corn starch or from about 10% to about 20%, wherein the high amylose corn starch has starch content greater than about 50% (wt. % or the high amylose starch %); d. a dextrin in an among from 5% to 20% (wt. %) or from about 5% to about 15%.
7. The dry solids coating composition of any one of claims 1 to 6 wherein the legume protein is a pea protein.
8. Fry batter comprising the dry solids coating composition of any one of claims 1 to 7 and aqueous solution, wherein the dry solids coating composition is in an amount from about 25% to 40% (wt. %) or from about 30% to about 40%, or about 32% to about 38%.
9. A food product comprising: an edible substrate and a coating wherein the coating comprises: a) 5% to about 35%, or to about 30%, or to about 25%, or from 7.5% or to about 35%, or to about 30%, or to about 25%, from about 10% to about 35%, or to about 30%, or to about 25%; b) from about 45% to about 95% of a starch mix (wt %) or from about 45% to about 90%, or from about 45% to about 85%, or from about 45% to about 75% or from about 45% to about 65% or from about 45% to about 55% wherein, optionally the edible substrate is a sweet potato, shrimp, or fish.
10. The food product of claim 9 wherein the coating comprises one or more of a legume flour, a wheat flour, a tapioca starch, waxy tapioca starch, and a rice flour, wherein optionally costing comprises a tapioca starch, waxy tapioca starch, and a rice flour.
11. The food product of claim 9 or 10 wherein the coating further comprises a high amylose corn starch and wherein, the high amylose corn starch has amylose content greater than about 50%.
12. The food product of any one of claims 9 to 11 wherein the starch mix comprises a thermally inhibited starch, optionally wherein the thermally inhibited starch is a tapioca starch or waxy tapioca starch.
13. The food product of any one of claims 9 to 12 wherein coating comprises:
a. from 15% to 40% (wt. %) of a thermally inhibited starch or from about 20%, or from 25% or from 30% to 40%; b. from 15% to 40% (wt. %) of a rice flour or from about 20%, or from 25% or from 30% to 40%; c. from about 5% to about 20% (wt. %) of a high amylose corn starch or from about 10% to about 20%, wherein the high amylose corn starch has starch content greater than about 50% (wt. % or the high amylose starch %); d. a dextrin in an among from 5% to 20% (wt. %) or from about 5% to about 15%.
14. The food product of any one of claims 9 to 13 wherein the coating consists essentially of: a. from 15% to 40% (wt. %) of a thermally inhibited starch or from about 20%, or from 25% or from 30% to 40%; b. from 15% to 40% (wt. %) of a rice flour or from about 20%, or from 25% or from 30% to 40%; c. from about 5% to about 20% (wt. %) of a high amylose corn starch or from about 10% to about 20%, wherein the high amylose corn starch has starch content greater than about 50% (wt. % or the high amylose starch %); d. a dextrin in an among from 5% to 20% (wt. %) or from about 5% to about 15%.
15. The food product of any one of claims 9 to 14 wherein the legume protein is a pea protein.
16. The food product of any one of claims 9 to 15 wherein substrate comprises sweet potato, or shrimp, or fish.
17. The food product of any one of claims 9 to 16 wherein the food product is a fried product.
18. The food product of any one of claims 9 to 17 wherein the food product is a baked product.
19. The food product of any one of claims 9 to 18 wherein the food product is a frozen product.
20. Use of a legume protein in a fry batter; wherein, optionally, the legume protein is a pea protein
21. Use of a legume protein in a fry batter as described in any foregoing claim.
22. Dry solids coating composition, fry batter, or food composition or use thereof as described in any foregoing claim being a gluten free.

The technology disclosed in this specification can be better understood with reference to the following examples, which are not intended to limit the full scope of the disclosed technologies.

### Example 1

This example analyses the effect of varying protein content on coating crispness of a legume protein-based fry batter. In this example peeled sweet potato fries were used as a substrate for the batter. Sweet potatoes were cut in strips and fully cooked (blanched in hot but not boiling water) and then dried at about 60° C. to a loss of about 12% (weight difference between sweet potato from blanching water to post drying). Sweet potato strips were hand battered and laid on bakers cooling racks and were measured for batter pick up. Batter pick was measured as follows: Weighed substrate (“W1”). Weighed substrate with coating/breading and record weight (“W1”). Weighed the tray with residual coating (no substrate) (W3). Calculate: % pick up=((W2−W1−W3)/W2)*100. Batter pick is reported in Table 3

Batter was made using either the formula of Table 1 or Table 2. Samples 1 and 3 were made according using the formula of Table 1. Sample 1 used a pea protein isolate having about 80% protein (wt. %). Sample 3 used a pea protein isolate having about 85% protein (wt. %). Sample 2 used a pea protein isolate having about 80% protein (wt. %). To make the batter all ingredients were mixed with water using a kitchen stand mixer and were standardized to roughly the same viscosity. Samples 1 and 3 had solids content of 34% and Sample 2 had solids content of about 30%. Viscosity was measured using a Stein Cup, which is cup of standardized form that is commonly used in the art to provide a viscosity measurement for batters. The cup was filled. Batters were made to have a viscosity of about 9 seconds to empty (top to break, which is measured at 6 inches from the bottom of the cup.) Stein viscosity is reported in Table 3

Batter coated sweet potato strips were fried in canola oil at about 190° C. for 60 seconds. Afterwards, fried strips were shaken to remove excess oil and transferred to a blast freezer within 2 minutes of frying and were frozen holding at about −23° C. for from 2 to 4 hours. Fried sweet potato strips were stored in conventional freezer (about −18° C.) for two weeks and were then baked at about 204° C. for 22 minutes.

Re-baked fried sweet potatoes were evaluated for texture by informal panel 5 to 10 minutes after being taken out of the oven. Results are reported in Table 4.

TABLE 1
Formula Sample 1 and Sample 3

| Solid Ingredients | Usage (wt. %) |
|---|---|
| Legume Protein Isolate | 20.60 |
| Functionalized Tapioca Starch\hat{ } | 20.50 |
| Rice Flour | 25.00 |
| High Amylose Corn Starch (at least about 65% | 12.00 |
| amylose) | |
| Dextrin | 15.00 |
| Salt | 4.70 |
| Sodium Acid Pyrophosphate #28 | 1.20 |
| Baking Soda | 1.00 |
| Total | 100.00 |

\hat{ }Tapioca starch was Novation 3600 available from Ingredion Incorporated.

TABLE 2
Formula for Sample 2

| Ingredient | Usage (wt. %) |
|---|---|
| Legume Protein Isolate | 35.00 |
| Functionalized Tapioca Starch | 10.00 |
| Rice Flour | 21.80 |
| High Amylose Corn Starch (at least about 65% | 12.00 |
| amylose wt. %) | |
| Dextrin | 15.00 |
| Salt | 4.70 |
| Sodium Acid Pyrophosphate #28 | 1.20 |
| Baking Soda | 1.00 |
| Total | 100.00 |

\hat{ }Tapioca starch used was Novation 3600 available from Ingredion Incorporated.

TABLE 3
Quantitative Batter Parameters

| | Batter Viscosity- Zahn | |
|---|---|---|
| | Cup #4 (seconds) | Batter Pick Up % |
| Sample 1 | 8.04 | 13.30% |
| Sample 2 | 8.30 | 13.16% |
| Sample 3 | 8.53 | 14.87% |

TABLE 4
Evaluation of Re-Baked Fried Sweet Potato Strips

| | Sensory Notes |
|---|---|
| Sample 1 | Good initial crisp, audible crunch and maintained |
| | crispiness through 15-minute hold |
| Sample 2 | Slight crisp, but softer than variable #1 and #3, darker in |
| | appearance |
| Sample 3 | Good initial crisp with audible crunch. Little to no |
| | difference compared to variable #1 |

As shown samples 1 and 3 provide increased protein content to fried sweet potato without compromising crispness.

1. A dry solids coating composition comprising separately by weight:
a) a pea protein isolate in amount 5% to about 35% wt. %;
b) from about 45% to about 95% of a starch mix wt. %.

2. The dry solids coating composition of claim 1 wherein the starch mix comprises one or more of a legume flour, a wheat flour, a tapioca starch, waxy tapioca starch, and a rice flour, wherein optionally the dry solids coating comprises a tapioca starch, waxy tapioca starch, and a rice flour.

3. The dry solids coating composition of claim 1 wherein the starch mix further comprises a high amylose corn starch, wherein, the high amylose corn starch has amylose content greater than about 50%.

4. The dry solids coating composition of claim 1 wherein the starch mix comprises a thermally inhibited starch.

5. The dry solids coating composition of claim 1 wherein the starch mix comprises:
a. from 15% to 40% (wt. %) of a thermally inhibited starch;
b. from 15% to 40% (wt. %) of a rice flour;
c. from about 5% to about 20% (wt. %) of a high amylose corn starch wherein the high amylose corn starch has starch content greater than about 50% (wt. % or the high amylose starch %);
d. a dextrin in an among from 5% to 20% (wt. %).

6. The dry solids coating composition of claim 1 wherein the starch mix consists essentially of:
a. from 15% to 40% (wt. %) of a thermally inhibited starch or from about 20%,;
b. from 15% to 40% (wt. %) of a rice flour;
c. from about 5% to about 20% (wt. %) of a high amylose corn starch wherein the high amylose corn starch has starch content greater than about 50% (wt. % or the high amylose starch %);
d. a dextrin in an among from 5% to 20% (wt. %).

7. (canceled)

8. A fry batter comprising:
a) a dry solids coating composition a pea protein isolate in amount 5% to about 35% wt. %; and from about 45% to about 95% of a starch mix wt. % and
b) an aqueous solution
wherein the dry solids coating composition is in an amount from about 25% to 40% (wt. %).

9. A food product comprising: an edible substrate and a coating wherein the coating comprises:
a) a pea protein isolate 5% to about 35% wt. %;
b) from about 45% to about 95% of a starch mix wt. %
wherein the edible substrate is a sweet potato, shrimp, or fish.

10. The food product of claim 9 wherein the coating comprises one or more of a legume flour, a wheat flour, a tapioca starch or waxy tapioca starch, and a rice flour, wherein optionally coating comprises a tapioca starch or waxy tapioca and a rice flour.

11. The food product of claim 9 wherein the coating further comprises a high amylose corn starch and wherein, the high amylose corn starch has amylose content greater than about 50%.

12. The food product of claim 9 wherein the starch mix comprises a thermally inhibited starch,.

13. The food product of claim 1 wherein coating comprises:
a. from 15% to 40% (wt. %) of a thermally inhibited starch;
b. from 15% to 40% (wt. %) of a rice flour;
c. from about 5% to about 20% (wt. %) of a high amylose corn starch, wherein the high amylose corn starch has starch content greater than about 50% (wt. % or the high amylose starch);
d. from 10% to 20% (wt. %) of a dextrin.

14. The food product of claim 9 wherein the coating consists essentially of:
a. from 15% to 40% (wt. %) of a thermally inhibited starch;
b. from 15% to 40% (wt. %) of a rice flour;
c. from about 5% to about 20% (wt. %) of a high amylose corn starch, wherein the high amylose corn starch has starch content greater than about 50% (wt. % or the high amylose starch %);
d. a dextrin in an among from 10% to 20% (wt. %).

15. (canceled)

16. The food product of claim 9 wherein substrate comprises sweet potato.

17. The food product of claim 9 wherein the food product is a fried product.

18. The food product of claim 9 wherein the food product is a baked product.

19. The food product of claim 9 wherein the food product is a frozen product.

20. (canceled)

21. (canceled)

22. The food product claim 9 being a gluten free.
